(19) United States
(12) Patent Application Publication
(10) Pub. No.: US 2024/0409069 A1
(43) Pub. Date: Dec. 12, 2024

(54) Trailer Braking Device

(71) Applicant: Bret Kaiser, Milton, WA (US)

(72) Inventor: Bret Kaiser, Milton, WA (US)

(21) Appl. No.: 18/207,208

(22) Filed: Jun. 8, 2023

(51) Int. Cl. B60T 8/17; B60L 7/00; B60T 8/32

(52) U.S. Cl. CPC B60T 8/1708; B60L 7/006; B60T 8/3205; B60T 8/323

(57) ABSTRACT

A trailer braking device includes tow vehicle that has plurality of wheels and a trailer that is towable behind the tow vehicle which has wheels to roll along a roadway when the trailer is being towed. A plurality of vehicle motors is attached to a respective one of the plurality of wheels associated with the tow vehicle. Each of the vehicle motors is actuatable into a braking condition for braking the tow vehicle. A plurality of trailer motors is each of the trailer motors is attached to a respective one of the wheels on the trailer. Each of the plurality of trailer motors is actuatable into a braking condition for braking the trailer or an assist condition for urging the trailer forwardly reducing fuel consumption of the tow vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to braking devices and more particularly pertains to a new braking device for braking a tow vehicle and a trailer using electric motors. The device includes a plurality of vehicle motors each attached to respective wheels on the vehicle. The device includes a plurality of trailer motors each attached to respective wheels on the trailer. Each of the vehicle motors and the trailer motors rotates in an opposite direction of the respective wheel for braking the respective wheel.

### (2) Description of Related Art Including Information Disclosed Under 37 CFR 1.97 and 1.98

The prior art relates to braking devices including a tractor trailer braking system involving an internal combustion engine and a plurality of regenerative braking systems with a generator that is driven by a braking system of a vehicle. Furthermore, the prior art discloses braking devices that include electric motors that are employed in conjunction with friction brakes for braking a heavy vehicle. In no instance does the prior art disclose a fully electric braking system that includes electric motors disposed on each of a plurality of drive wheels of a tow vehicle and a plurality of wheels on a trailer for braking the tow vehicle and the trailer.

### BRIEF SUMMARY OF THE INVENTION

An embodiment of the disclosure meets the needs presented above by generally comprising a tow vehicle that has plurality of wheels and a trailer that is towable behind the tow vehicle which has wheels to roll along a roadway when the trailer is being towed. A plurality of vehicle motors is attached to a respective one of the plurality of wheels associated with the tow vehicle. Each of the vehicle motors is actuatable into a braking condition for braking the tow vehicle. A plurality of trailer motors is each of the trailer motors is attached to a respective one of the wheels on the trailer. Each of the plurality of trailer motors is actuatable into a braking condition for braking the trailer or an assist condition for urging the trailer forwardly reducing fuel consumption of the tow vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a tow vehicle of an embodiment of the disclosure.

FIG. 2 is a left side phantom view of a trailer of an embodiment of the disclosure.

FIG. 3 is a schematic view of an embodiment of the disclosure.

FIG. 4 is a perspective in-use view a trailer braking device according to an embodiment of the disclosure showing a tow vehicle and a trailer going downhill.

FIG. 5 is a perspective in-use view of an embodiment of the disclosure showing a tow vehicle and a trailer going uphill.

FIG. 6 is a magnified detail view taken from circle 6 of FIG. 4 of an embodiment of the disclosure.

### DETAILED DESCRIPTION OF THE INVENTION

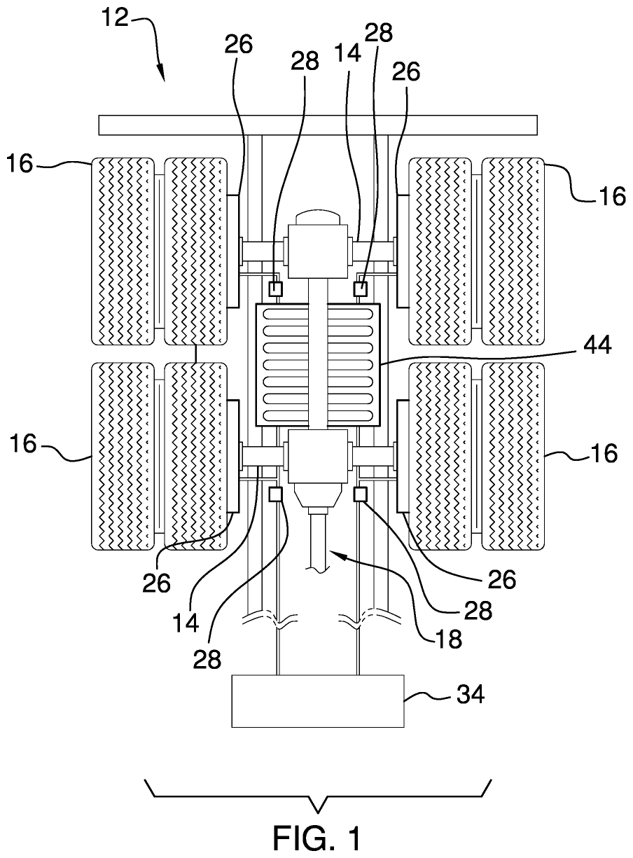

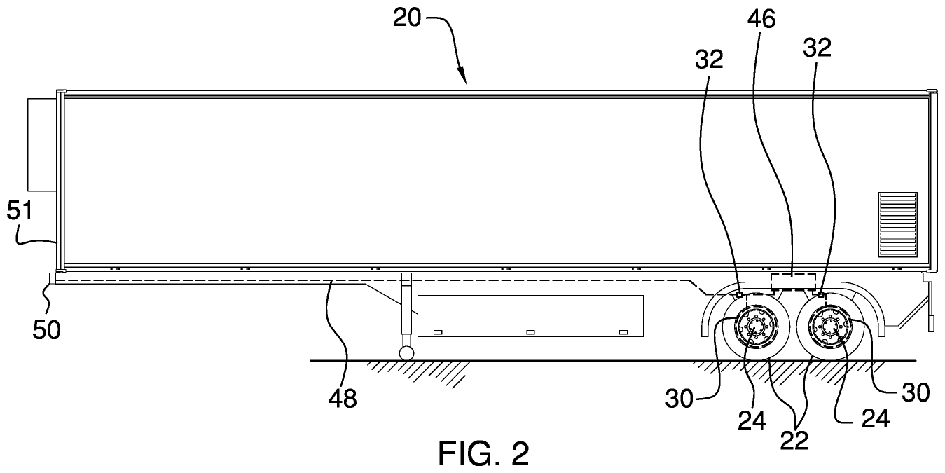

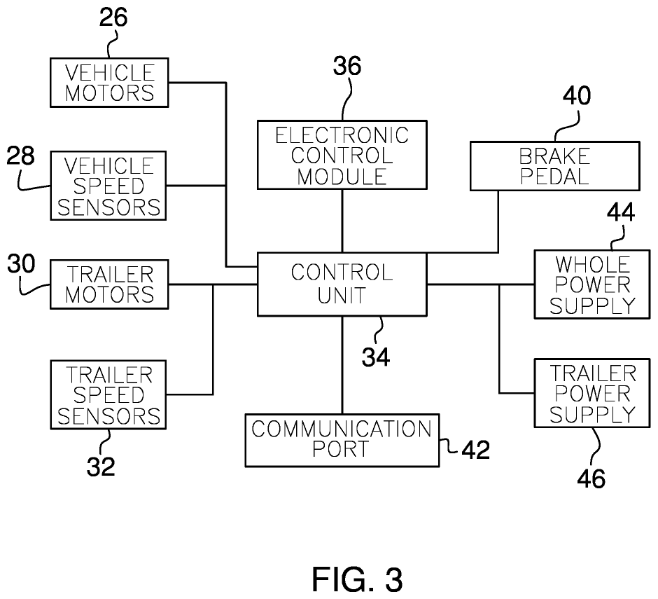

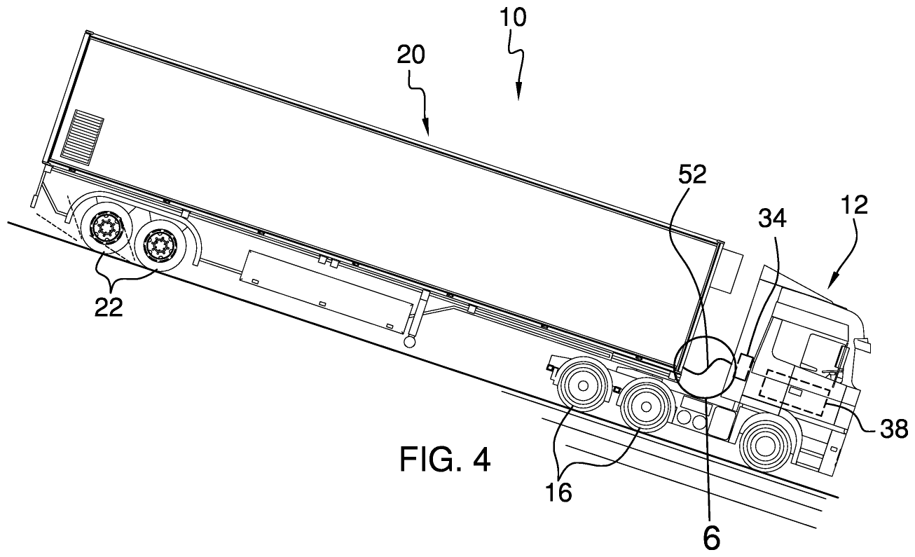

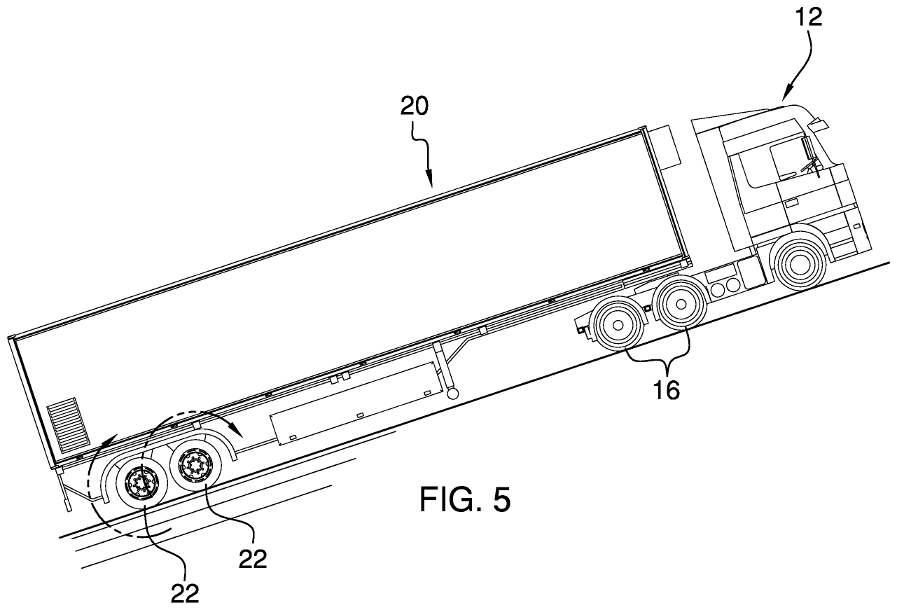

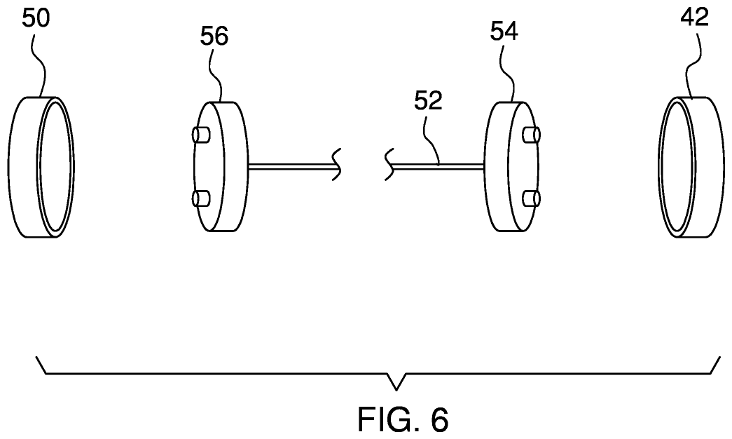

With reference now to the drawings, and in particular to FIGS. 1 through 6 thereof, a new braking device embodying the principles and concepts of an embodiment of the disclosure and generally designated by the reference numeral 10 will be described.

As best illustrated in FIGS. 1 through 6, the trailer braking device 10 generally comprises a tow vehicle 12 that has a plurality of rear axles 14 and a plurality of wheels 16 each rotatably disposed on a respective one of the rear axles 14 to roll along a roadway. Each of the rear axles 14 is in mechanical communication with a power train 18 of the tow vehicle 12. The tow vehicle 12 may be semi tractor or other type of diesel truck commonly employed for commercial transportation of cargo. A trailer 20 is towable behind the tow vehicle 12 and the trailer 20 has a plurality of wheels 22 each rotatably attached to a respective one of a plurality of axles 24 to roll along a roadway when the trailer 20 is being towed. The trailer 20 may be a refrigerator trailer, a flatbed trailer, a box trailer or any other type of trailer commonly employed for commercial transportation of cargo.

A plurality of vehicle motors 26 is each attached to a respective one of the pair of rear axles 14 of the tow vehicle 12. Each of the vehicle motors 26 is in mechanical communication with a respective one of the plurality of wheels 16 associated with the tow vehicle 12. Furthermore, each of the vehicle motors 26 is actuatable into a braking condition having the vehicle motors 26 rotating in an opposite direction with respect to the plurality of wheels 16 associated with the tow vehicle 12 for braking the tow vehicle 12. Each of the vehicle motors 26 may comprise a reverse polarity electric motor or the like and each of the vehicle motors 26 may employ a friction clutch, or other type of slip drive, for engaging the respective wheel 16.

A plurality of vehicle speed sensors 28 is provided and each of the vehicle speed sensors 28 is integrated into the tow vehicle 12. Each of the vehicle speed sensors 28 is in communication with a respective one of the wheels 16 on the tow vehicle 12. In this way each of the plurality of vehicle speed sensors 28 can sense the rotational speed of the respective wheel 16 on the tow vehicle 12. Additionally, each of the vehicle speed sensors 28 may comprise electronic wheel speed sensors of any conventional design that are commonly employed in the automotive industry.

A plurality of trailer motors 30 is provided and each of the trailer motors 30 is attached to a respective one of the plurality of axles 24 on the trailer 20. Additionally, each of the trailer motors 30 is in mechanical communication with a respective one of the wheels 22 on the trailer 20. Each of the plurality of trailer motors 30 is actuatable into a braking condition having each of the plurality of trailer motors 30 rotating in an opposite direction with respect to the plurality of wheels 22 associated with the trailer 20 for braking the trailer 20. Each of the plurality of trailer motors 30 is actuatable into an assist condition having each of the plurality of trailer motors 30 rotating in the same direction as the plurality of wheels 22 associated with the trailer 20. In this way the plurality of trailer motors 30 urge the trailer 20 forwardly to assist the tow vehicle 12 with towing the trailer 20 up an incline thereby reducing fuel consumption of the tow vehicle 12. Each of the plurality of trailer motors 30 may comprise a reverse polarity electric motor or the like and each of the trailer motors 30 may employ a friction clutch, or other type of slip drive, for engaging the respective wheel 22 on the trailer 20.

A plurality of trailer speed sensors 32 is provided and each of the trailer speed sensors 32 is integrated into the trailer 20. Each of the trailer speed sensors 32 is in communication with a respective one of the wheels on the trailer 20 thereby facilitating each of the plurality of trailer speed sensors 32 to sense the rotational speed of the respective wheel 22 on the trailer 20. Each of the trailer speed sensors 32 may comprise an electronic wheel speed sensor commonly employed in the automotive industry. A control unit 34 is provided and the control unit 34 is integrated into the tow vehicle 12. The control unit 34 is in electrical communication with an electronic control module 36 of the tow vehicle 12 thereby facilitating the control unit 34 to receive information pertaining to operational parameters of an engine 38 in the tow vehicle 12 and a brake pedal 40 in the tow vehicle 12.

The control unit 34 is in electrical communication with each of the vehicle speed sensors 28 and the control unit 34 is in electrical communication with each of the trailer speed sensors 32. Additionally, the control unit 34 is in communication with each of the plurality of vehicle motors 26 and each of the plurality of trailer motors 30. The control unit 34 actuates each of the plurality of vehicle motors 26 into the braking condition when the control unit 34 detects that the brake pedal 40 in the tow vehicle 12 is depressed for slowing the tow vehicle 12. Additionally, the control unit 34 actuates each of the trailer motors 30 into the braking condition when the control unit 34 detects that the brake pedal 40 in the tow vehicle 12 is depressed for slowing the trailer 20. Conversely, the control unit 34 actuates each of the trailer motors 30 into the assist condition when the control unit 34 detects that the engine 38 in the tow vehicle 12 is attempting to accelerate and the plurality vehicle speed sensors 28 and the plurality of trailer speed sensors 32 senses a decrease in speed.

The control unit 34 includes a communication port 42 that is positioned in a conspicuous location on the tow vehicle 12. A vehicle power supply 44 is integrated into the tow vehicle 12 and the vehicle power supply 44 is electrically coupled to each of the plurality of vehicle motors 26. The vehicle power supply 44 may comprise a plurality of rechargeable batteries that are electrically coupled to an alternator of the tow vehicle 12 for charging the rechargeable batteries. A trailer power supply 46 is integrated into the trailer 20 and the trailer power supply 46 is electrically coupled to each of the plurality of trailer motors 30. A conductor cable 48 is routed along an undercarriage of the trailer 20 and the conductor cable 48 is electrically coupled to each of the trailer speed sensors 32 and each of the trailer motors 30 and the trailer power supply 46. Furthermore, the conductor cable 48 terminates at a communication port 50 that is disposed on a front end 51 of the trailer 20.

A connection cable 52 is provided which has a first plug 54 that is matable to the communication port 50 on the front end 51 of the trailer 20. The connection cable 52 has a second plug 56 that matable to the communication port 42 on the tow vehicle 12. In this way the control unit 34 can be placed in electrical communication with each of the plurality of trailer motors 30 and each of the plurality of trailer speed sensors 32. The communication port 50 on the front end 51 of the trailer 20 and the communication port 42 on the tow vehicle 12 may comprise a female electrical socket and each of the first plug 54 and the second plug 56 may comprise a male electrical plug.

In use, each of the vehicle motors 26 and the trailer motors 30 are actuated into the braking condition when the brake pedal 40 in the tow vehicle 12 is depressed. In this way tow vehicle 12 and the trailer 20 can be slowed or stopped without the use of air brakes as are commonly employed on the commercial transportation industry. Conventional air brake systems are prone to a variety of failure conditions, including loss or air pressure, overheating brake pads and braking system fires. The vehicle motors 26 and the trailer motors 30 facilitate the tow vehicle 12 and the trailer 20 to be braked without the risk of air pressure loss, overheated brake pads or braking system fires. Additionally, the trailer motors 30 are actuated into the assist condition when the trailer 20 is being towed up an incline. In this way the fuel consumption of the tow vehicle 12 is reduced thereby enhancing the overall full efficiency of the tow vehicle 12.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A trailer braking device employing reverse polarity engines to brake wheels of a trailer, said device comprising:
a tow vehicle having a plurality of rear axles and a plurality of wheels each being rotatably disposed on a respective one of said rear axles wherein said plurality of wheels is configured to roll along a roadway, each of said rear axles being in mechanical communication with a power train of said tow vehicle;
a trailer being towable behind said tow vehicle, said trailer having a plurality of wheels each being rotatably attached to a respective one of a plurality of axles wherein said plurality of wheels on said trailer is configured to roll along a roadway when said trailer is being towed;
a plurality of vehicle motors, each of said plurality of vehicle motors being attached to a respective one of said pair of rear axles of said tow vehicle, each of said vehicle motors being in mechanical communication with a respective one of said plurality of wheels associated with said tow vehicle, each of said vehicle motors being actuatable into a braking condition having said vehicle motors rotating in an opposite direction with respect to said plurality of wheels associated with said tow vehicle for braking said tow vehicle;
a plurality of trailer motors, each of said trailer motors being attached to a respective one of said plurality of axles on said trailer, each of said trailer motors being in mechanical communication with a respective one of said wheels on said trailer, each of said plurality of trailer motors being actuatable into a braking condition having each of said plurality of trailer motors rotating in an opposite direction with respect to said plurality of wheels associated with said trailer for braking said trailer, each of said plurality of trailer motors being actuatable into an assist condition having each of said plurality of trailer motors rotating in the same direction as said plurality of wheels associated with said trailer for urging said trailer forwardly wherein said plurality of trailer motors is configured to assist said tow vehicle with towing said trailer up an incline thereby reducing fuel consumption of said tow vehicle; and
a control unit being integrated into said tow vehicle, said tow unit being in electrical communication a brake pedal in said tow vehicle, said control unit being in communication with each of said plurality of vehicle motors and each of said plurality of trailer motors, said control unit actuating each of said plurality of vehicle motors into said braking condition when said control unit detects that said brake pedal in said tow vehicle is depressed for slowing said tow vehicle, said control unit actuating each of said trailer motors into said braking condition when said control unit detects that said brake pedal in said tow vehicle is depressed for slowing said trailer.

2. The device according to claim 1, further comprising:
a plurality of vehicle speed sensors, each of said vehicle speed sensors being integrated into said tow vehicle, each of said vehicle speed sensors being in communication with a respective one of said wheels on said tow vehicle thereby facilitating each of said plurality of vehicle speed sensors to sense the rotational speed of said respective wheel on said tow vehicle; and
a plurality of trailer speed sensors, each of said trailer speed sensors being integrated into said trailer, each of said trailer speed sensors being in communication with a respective one of said wheels on said trailer thereby facilitating each of said plurality of trailer speed sensors to sense the rotational speed of said respective wheel on said trailer.

3. The device according to claim 2, wherein:
said control unit is in electrical communication with each of said trailer speed sensors and each of said vehicle speed sensors; and
said control unit is in electrical communication with an electronic control module of said tow vehicle thereby facilitating said control unit to receive information pertaining to operational parameters of an engine in said tow vehicle; and
said control unit actuates each of said trailer motors into said assist condition when said control unit detects that said engine in said tow vehicle is attempting to accelerate and said plurality vehicle speed sensors and said plurality of trailer speed sensors senses a decrease in speed.

4. The device according to claim 1, further comprising
a trailer power supply being integrated into said trailer, said trailer power supply being electrically coupled to each of said plurality of trailer motors; and
a conductor cable being routed along an undercarriage of said trailer, said conductor cable being electrically coupled to each of said trailer speed sensors and each of said trailer motors and said trailer power supply, said conductor cable terminating at a communication port being disposed on a front end of said trailer.

5. The device according to claim 4, wherein:
said device includes a plurality of trailer speed sensors each being integrated into said trailer;
said control unit includes a communication port being positioned in a conspicuous location on said tow vehicle; and
said device includes a connection cable having a first plug being matable to said communication port on said front end of said trailer, said connection cable having a second plug being matable to said communication port on said tow vehicle thereby facilitating said control unit to be in electrical communication with each of said plurality of trailer motors and each of said plurality of trailer speed sensors.

6. A trailer braking device employing reverse polarity engines to brake wheels of a trailer, said device comprising:
a tow vehicle having a plurality of rear axles and a plurality of wheels each being rotatably disposed on a respective one of said rear axles wherein said plurality of wheels is configured to roll along a roadway, each of said rear axles being in mechanical communication with a power train of said tow vehicle;
a trailer being towable behind said tow vehicle, said trailer having a plurality of wheels each being rotatably attached to a respective one of a plurality of axles wherein said plurality of wheels on said trailer is configured to roll along a roadway when said trailer is being towed;
a plurality of vehicle motors, each of said plurality of vehicle motors being attached to a respective one of said pair of rear axles of said tow vehicle, each of said vehicle motors being in mechanical communication with a respective one of said plurality of wheels associated with said tow vehicle, each of said vehicle motors being actuatable into a braking condition having said vehicle motors rotating in an opposite direction with respect to said plurality of wheels associated with said tow vehicle for braking said tow vehicle;
a plurality of vehicle speed sensors, each of said vehicle speed sensors being integrated into said tow vehicle, each of said vehicle speed sensors being in communication with a respective one of said wheels on said tow vehicle thereby facilitating each of said plurality of vehicle speed sensors to sense the rotational speed of said respective wheel on said tow vehicle;
a plurality of trailer motors, each of said trailer motors being attached to a respective one of said plurality of axles on said trailer, each of said trailer motors being in mechanical communication with a respective one of said wheels on said trailer, each of said plurality of trailer motors being actuatable into a braking condition having each of said plurality of trailer motors rotating in an opposite direction with respect to said plurality of wheels associated with said trailer for braking said trailer, each of said plurality of trailer motors being actuatable into an assist condition having each of said plurality of trailer motors rotating in the same direction as said plurality of wheels associated with said trailer for urging said trailer forwardly wherein said plurality of trailer motors is configured to assist said tow vehicle with towing said trailer up an incline thereby reducing fuel consumption of said tow vehicle;
a plurality of trailer speed sensors, each of said trailer speed sensors being integrated into said trailer, each of said trailer speed sensors being in communication with a respective one of said wheels on said trailer thereby facilitating each of said plurality of trailer speed sensors to sense the rotational speed of said respective wheel on said trailer;
a control unit being integrated into said tow vehicle, said tow unit being in electrical communication with an electronic control module of said tow vehicle thereby facilitating said control unit to receive information pertaining to operational parameters of an engine in said tow vehicle and a brake pedal in said tow vehicle, said control unit being in electrical communication with each of said vehicle speed sensors, said control unit being in electrical communication with each of said trailer speed sensors, said control unit being in communication with each of said plurality of vehicle motors and each of said plurality of trailer motors, said control unit actuating each of said plurality of vehicle motors into said braking condition when said control unit detects that said brake pedal in said tow vehicle is depressed for slowing said tow vehicle, said control unit actuating each of said trailer motors into said braking condition when said control unit detects that said brake pedal in said tow vehicle is depressed for slowing said trailer, said control unit actuating each of said trailer motors into said assist condition when said control unit detects that said engine in said tow vehicle is attempting to accelerate and said plurality vehicle speed sensors and said plurality of trailer speed sensors senses a decrease in speed, said control unit including a communication port being positioned in a conspicuous location on said tow vehicle;
a vehicle power supply being integrated into said tow vehicle, said vehicle power supply being electrically coupled to each of said plurality of vehicle motors;
a trailer power supply being integrated into said trailer, said trailer power supply being electrically coupled to each of said plurality of trailer motors;
a conductor cable being routed along an undercarriage of said trailer, said conductor cable being electrically coupled to each of said trailer speed sensors and each of said trailer motors and said trailer power supply, said conductor cable terminating at a communication port being disposed on a front end of said trailer; and
a connection cable having a first plug being matable to said communication port on said front end of said trailer, said connection cable having a second plug being matable to a communication port on said tow vehicle thereby facilitating said control unit to be in electrical communication with each of said plurality of trailer motors and each of said plurality of trailer speed sensors.
